(19) United States
(12) Patent Application Publication
(10) Pub. No.: US 2025/0225234 A1
(43) Pub. Date: Jul. 10, 2025

(54) APPARATUSES, COMPUTER-IMPLEMENTED METHODS, AND COMPUTER PROGRAM PRODUCTS FOR DETECTING ANOMALOUS CYBER ACTIVITY

(71) Applicant: Honeywell International Inc., Charlotte, NC (US)

(72) Inventors: Muthuramlingam Manickam, Vannarpettai (IN); Nagarajan Sudalaimani, Aanaiyur Post (IN); Pandurengan G, Paravai (IN)

(21) Appl. No.: 18/406,347

(22) Filed: Jan. 8, 2024

(51) Int. Cl. G06F 21/55

(52) U.S. Cl. CPC G06F 21/554; G06F 2221/034

(57) ABSTRACT

Embodiments of the disclosure provide for detection and mitigation of anomalous cyber activity in a computing environment. Some embodiments monitor system data associated with an operation occurring in a computing environment. Some embodiments predict a predictive output using a machine learning (ML) model and based on the system data. In some embodiments, the predictive output is indicative of whether the system data is associated with one of a plurality of anomalous event definitions. In some embodiments, the ML model generates the predictive output based on whether the system data indicates an aspect of an anomalous event as defined by a plurality of intrusion detection models. In some embodiments, the ML model is trained on historical classifications of data processed using the plurality of intrusion models. Some embodiments in response to the predictive output, perform a response action that reduces vulnerability of the computing environment to anomalous activity in the operation.

### TECHNOLOGICAL FIELD

Embodiments of the present disclosure are generally directed to detecting and responding to anomalous activity in one or more computing environments.

### BACKGROUND

Existing approaches to detecting anomalous cyber activities in computing environments typically rely on a security analyst modeling data respective to an intrusion model. For example, traditional anomalous event detection may include a security analyst reviewing activity in a computing environment to determine if the activity is similar to historical anomalous events as defined by an intrusion model. However, these personnel-reliant approaches to detecting anomalous activities may fail to identify anomalous events in real-time, thereby increasing vulnerability of computing environments to operations associated with the anomalous event. In addition, a single intrusion model may account for only a subset of the full scope of potential anomalous activities that occur in computing environment.

Applicant has discovered various technical problems associated with conventional anomalous activity detection techniques. Through applied effort, ingenuity, and innovation, Applicant has solved many of these identified problems by developing the embodiments of the present disclosure, which are described in detail below.

### BRIEF SUMMARY

In general, embodiments of the present disclosure herein provide for improved anomalous activity detection and response using machine learning models and multiple intrusion models. Other implementations for detecting and responding to anomalous activities using machine learning models and a plurality of intrusion models will be, or will become, apparent to one with skill in the art upon examination of the following figures and detailed description. It is intended that all such additional implementations be included within this description be within the scope of the disclosure, and be protected by the following claims.

In various embodiments, provided herein is an anomalous activity prediction system configured to predict a predictive output that is indicative of whether system data is associated with one or more anomalous event definitions. In some embodiments, the predictive output is based on whether the system data indicates one or more aspects of an anomalous event as defined by a plurality of intrusion models. In various embodiments, the anomalous activity prediction system processes data using the plurality of intrusions models to generate historical classifications of data. The historical classifications of data may define aspects of historical anomalous events. In some embodiments, using the historical classifications of data, the anomalous activity prediction system trains one or more machine learning models to predict predictive outputs for use in detecting and responding to anomalous activity in a computing environment. The machine learning model may leverage the intelligence of multiple intrusion models to detect a wider spectrum of anomalous activities as compared to existing approaches that rely upon a single intrusion model.

In some embodiments, machine-learning based detection techniques of the anomalous activity prediction system enable identification and response to anomalous activities in substantially real-time, which may reduce detection latencies associated with existing approaches that are reliant upon inspection of system data by a security analyst. In some embodiments, the anomalous activity prediction system leverages machine learning models and multiple intrusion models to detect and respond to anomalous events in their earlier stages, such as prior to exploitation or remote manipulation of a computing environment.

In some embodiments, a first model utilized by the anomalous activity prediction system is configured to generate associations between one or more operations occurring in a computing environment and one or more historical data patterns based at least in part on a comparison of system data to the respective historical data patterns. The anomalous activity prediction system may define one or more aspects of an anomalous event is based at least in part on the association between the operation and the historical data pattern. The anomalous event definition may be subsequently leveraged by a machine learning model to predict whether system data is associated with anomalous activity. In some embodiments, the first model embodies or is based on one or more knowledge bases for classifying tactics and techniques of anomalous activities and perpetrators thereof. For example, the first model may embody or be derived from an adversarial tactics, techniques, and common knowledge (ATT&CK) knowledge base.

In some embodiments, a second model utilized by the anomalous activity prediction system is configured to is configured to associate one or more operations occurring in a computing environment with one or more of a plurality of intrusion phases, where the plurality of intrusion phases may be defined with respect to system data associated with the operations. The anomalous activity prediction system may define one or more aspects of an anomalous event determined based at least in part on the plurality of intrusion phases, which may improve the ability of a machine learning model to predict whether system data is associated with the anomalous event definition. In some embodiments, the plurality of phases embody or include one or more phases of a cyber kill chain including reconnaissance phase, weaponization phase, delivery phase, exploitation phase, installation phase, command and control phase, and action on objectives phase.

In some embodiments, a third model utilized by the anomalous activity prediction system is configured to generate event data objects based on system data, where the event data objects are representative of operations occurring on one or more computing environments. The anomalous activity prediction system may define one or more aspects of an anomalous event based on respective comparisons between the event data object and a plurality of anomalous event definitions, where each definition may include an event data object corresponding to the anomalous event. In some embodiments, the event data object embodies or includes a diamond model of event intrusion analysis, which is typically used by analysts to hunt, pivot, analyze, group, and structure mitigation actions against intrusions to a computing environment. For example, the anomalous activity prediction system may generate a first diamond model based on system data associated with an operation occurring in a computing environment. The anomalous activity prediction system may compare the first diamond model to respective diamond models of one or more anomalous event definitions to predict whether the system data is associated with an anomalous event definition.

In various embodiments, using combinations of intelligence from the plurality of intrusion models, the anomalous activity prediction system trains machine learning models to detect for behavior patterns of anomalous activities, which may enable the anomalous activity prediction system to initiate actions for reducing the vulnerability of computing environments to the anomalous activities. In some embodiments, the actions performed by the anomalous activity prediction system include development phase actions and runtime phase actions. In some embodiments, the development phase actions refer to actions for generating and applying preventative security protocols to computing environments to reduce vulnerability of the computing environments to anomalous activities. In some embodiments, the runtime phase actions refer to actions for responding anomalous activities currently occurring on a computing environment in real-time. In some embodiments, the runtime activities include generating and provisioning alerts to computing environment administrators, suspending or blocking operations occurring in the computing environment, disabling communication access of a computing device to the computing environment, disabling one or more user accounts associated with the computing environment, retraining machine learning models, generating new anomalous event definitions, and/or the like.

In accordance with a first aspect of the disclosure, a computer-implemented method for reducing vulnerability of a computing environment to anomalous activities is provided. The computer-implemented method is executable utilizing any of a myriad of computing device(s) and/or combinations of hardware, software, firmware. In some example embodiments an example computer-implemented method includes monitoring system data associated with at least one operation occurring in at least one computing environment; predicting a predictive output, using at least one machine learning model and based at least in part on the system data, the predictive output indicative of whether the system data is associated with at least one of a plurality of anomalous event definitions, wherein the at least one machine learning model is i) configured to generate the predictive output based on whether at least a portion of the system data indicates an aspect of an anomalous event as defined by a plurality of intrusion detection models, and ii) wherein the at least one machine learning model is trained on historical classifications of data processed using the plurality of intrusion models, and in response to the predictive output, perform at least one response action that reduces vulnerability of the at least one computing environment to anomalous activity in the at least one operation.

In some example embodiments, the system data comprises at least one of network data or device data. In some example embodiments, performing the at least one response action comprises: generating at least one alert comprising the system data and the at least one anomalous event definition; and causing provision of the alert to at least one computing device associated with an administrator of the at least one computing environment. In some example embodiments, the system data comprises live data collected in real-time from the at least one computing environment.

In some example embodiments, performing the at least one response action comprises suspending or blocking the at least one operation. In some example embodiments, performing the at least one response action comprises disabling communication access of at least one computing device to the at least one computing environment. In some example embodiments, performing the at least one response action comprises disabling a user account associated with the at least one operation occurring in the at least one computing environment. In some example embodiments, performing the at least one response action comprises retraining the at least one machine learning model based at least in part on the system data.

In some example embodiments, generating at least one security protocol based at least in part on the at least one anomalous event definition; and causing provision of the at least one security protocol to at least one computing device associated with an administrator of the at least one computing environment. In some example embodiments, the at least one security protocol defines at least one adjustment to account authentication policies, and the at least one adjustment indicates an implementation of at least one of account lockout protocol, multifactor authentication protocol, or credential management protocol. In some example embodiments, the at least one security protocol defines at least one adjustment to subsequent real-time monitoring of operations occurring on the at least one computing environment, the at least one adjustment is associated with at least one of application log monitoring, command monitoring, or user account monitoring. In some example embodiments, the at least one security protocol defines at least one data management process to reduce vulnerability of the at least one computing environment to unauthorized data manipulation, and the at least one data management process comprises at least one of data backup, data modification monitoring, or data encryption. In some example embodiments, the at least one security protocol defines at least one communication control process to reduce vulnerability of the at least one computing environment to network intrusion, and the at least one communication control process comprises at least one of signature verification, communication content filtering, or network traffic flow monitoring

In some example embodiments, the method further comprises, in response to the predictive output failing to match a respective anomalous event threshold for any of the plurality of abnormal event definitions: generating a new anomalous event definition based at least in part on the system data and at least one classification of the system data from the plurality of intrusion models; and storing the new anomalous event definition in a data store that comprises the plurality of anomalous event definitions. In some example embodiments, the method comprises performing the at least one response action in response to determining the predictive output meets a respective anomalous event threshold for the at least one anomalous event definition.

In some example embodiments, each of the plurality of anomalous event definitions is associated with at least one historical data pattern; and a first model of the plurality of intrusion detection models is configured to: generate an association between the at least one operation and at least one historical data pattern based at least in part on a comparison of the system data to the respective historical data patterns, wherein the aspect of the anomalous event is defined based at least in part on the association between the at least one operation and the at least one historical data pattern. In some example embodiments, a second model of the plurality of intrusion detection models is configured to associate the at least one operation with at least one of a plurality of intrusion phases determined based at least in part on the system data, wherein the aspect of the anomalous event is further defined based at least in part on the at least one of the plurality of intrusion phases. In some example embodiments, a third model of the plurality of intrusion models is configured to generate an event data object representative of the at least one operation based at least in part on the system data; and the aspect of the anomalous event is further defined based at least in part on respective comparisons between the event data object and the plurality of anomalous event definitions.

In accordance with another aspect of the present disclosure, a computing apparatus for improved data loss prevention is provided. The computing apparatus in some embodiments includes at least one processor and at least one non-transitory memory, the at least non-transitory one memory having computer-coded instructions stored thereon. The computer-coded instructions in execution with the at least one processor causes the apparatus to perform any one of the example computer-implemented methods described herein. In some other embodiments, the computing apparatus includes means for performing each step of any of the computer-implemented methods described herein.

In accordance with another aspect of the present disclosure, a computer program product for improved data loss prevention is provided. The computer program product in some embodiments includes at least one non-transitory computer-readable storage medium having computer program code stored thereon. The computer program code in execution with at least one processor is configured for performing any one of the example computer-implemented methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a system that may be specially configured within which embodiments of the present disclosure may operate.

FIG. 2 illustrates a block diagram of an example apparatus that may be specially configured in accordance with at least some example embodiments of the present disclosure.

FIG. 3 illustrates an example workflow in accordance with at least some example embodiments of the present disclosure.

FIG. 4 illustrates a flowchart depicting operations of an example process for reducing vulnerability of a computing environment to anomalous activity in accordance with at least some example embodiments of the present disclosure.

### DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

Embodiments of the present disclosure provide a myriad of technical advantages in the technical field of anomalous activity detection and mitigation. Some embodiments utilize machine learning models and blended intelligence from a plurality of intrusion models to predict whether operations of a computing environment are associated with anomalous activity and perform response actions based on the predictions. Such processes and techniques may reduce vulnerability of computing environments to the anomalous activity.

### Definitions

“Operation” refers to any action or activity in a computing environment. In some embodiments, an operation includes accessing or viewing data, copying data, sending data, collecting data, deleting data, modifying data, and/or the like. In some embodiments, an operation includes installing or uninstalling programs, files, and/or the like. In some embodiments, an operation includes configuring one or more settings of the computing environment. In some embodiments, an operation includes causing performance of one or more processes, actions, and/or the like by the computing environment, or causing the computing environment to instruct other computing devices or computing environments to perform processes, actions, and/or the like. In one example, an operation may include installing a backdoor to enable communication with one or more servers via the computing environment. In another example, an operation may include collecting browser bookmark information, clipboard data, and/or the like. As another example, an operation may include accessing account passwords, password hashes, and/or the like. In still another example, an operation may include executing, at the computing environment, one or more commands, operational tasks, and/or the like using a configuration management program of the computing environment. In another example, an operation may include encrypting one or more files stored by the computing environment.

“System data” refers to any data associated with a computing environment. In some embodiments, system data includes commands, processes, tasks, and/or the like that are executed by a computing environment. In some embodiments, system data includes device data, where device data refers to any data that identifies or is received from a computing device. In some embodiments, system data includes network data, where network data refers to any data being (or having been) communicated to, within, or from a computing environment. In some embodiments, system data includes computing environment settings, configurations, operating parameters, and/or the like. In some embodiments, system data includes communications provisioned from or to the computing environment. In some embodiments, system data includes any data objects that define interactions between the computing environment and one or more user accounts, computing devices, and/or the like. For example, system data may include services, functions, and/or the like that are performed by the computing environment on behalf of or respective to a user account. As another example, system data may include data provisioned to or received from one or more computing devices. In some embodiments, system data includes programs installed at or removed from a computing environment. In some embodiments, system data includes modifications to a program installed at a computing environment. In some embodiments, system data includes any data stored at the computing environment. For example, system data may include data associated with computing environment users, administrators, and/or the like, such as credentials for accessing the computing environment, settings for controlling privileges of users and/or the computing environment, data stored by the computing environment on behalf of users, or data that defines historical interactions between the computing environment and users. In various embodiments, where system data is obtained in real-time and/or associated with operations occurring on a computing environment in real-time, said system data is referred to as “live data.”

“Anomalous event” refers to any instance of unauthorized or exploitative behavior that is associated with a computing environment. In some embodiments, an anomalous event includes an operation performed at or on the computing environment that is associated with unauthorized access of data at the computing environment, unauthorized changes to the computing environment, or unauthorized execution of functionality by the computing environment. In some embodiments, an anomalous event includes an operation performed on the computing environment that increases vulnerability of the computing environment to exploitation by malicious actors. For example, an anomalous event may include unauthorized generation of a backdoor for enabling command of or communication with a computing environment by a second computing environment. As another example, an anomalous event may include encryption of user data (e.g., ransomware) or decryption of user data (e.g., sensitive data disclosure), such as credentials, action logs, and/or the like. In still another example, an anomalous event may include communication of data from the computing environment to one or more computing devices. In another example, an anomalous event may include reconfiguration or removal of one or more settings of the computing environment, such as data security protocols, user access policies, and/or the like.

“Anomalous event definition” refers to any data object that describes an anomalous event. For example, an anomalous event definition may define computing environment behaviors, interactions, operations, and/or the like that may indicate occurrence of an anomalous event. In some embodiments, an anomalous event definition includes information that identifies one or more techniques by which a computing environment may be exploited, taken over, or compromised. In some embodiments, an anomalous event definition includes information that identifies known or suspected instigators of anomalous events. For example, an anomalous event definition may include device data, action logs, and/or the like of computing devices that are associated with historical occurrences of anomalous events. In some embodiments, an anomalous event definition includes patterns of computing environment operations that indicate occurrence of an anomalous event.

“Predictive output” refers to any output of a machine learning model that indicates a likelihood that system data is associated with an anomalous event definition. In some embodiments, a predictive output is generated based at least in part on an input including system data, data objects generated based at least in part on system data (e.g., event data objects, associations of system with historical data patterns, intrusion phases, and or the like), metadata associated with system data (e.g., timestamps, device or network identifiers, and/or the like), and/or the like. In some embodiments, a predictive output includes a Boolean outcome of TRUE or FALSE, which indicates whether an input comprising system data is associated with one or more anomalous event definitions. In some embodiments, a predictive output includes a score that quantifies a level of likelihood that system data is associated with one or more anomalous event definitions. For example, a predictive output may embody a value 0.0-1.0 in which 0.0 represents a lowest level of likelihood that system data is associated with an anomalous event definition and 1.0 represents a highest level of likelihood that the system data is associated with an anomalous event definition. In some embodiments, a predictive output includes a plurality of scores that are each associated with a different anomalous event definition such that ranking of the anomalous event definitions may be generated based on the plurality of scores.

“Machine learning model” refers to algorithmic model, statistical model, and/or the like that generates a predictive output, or plurality thereof, based at least in part on one or more inputs. In some embodiments, the machine learning model is trained on historical classifications of data processed using a plurality of intrusion models. Non-limiting examples of models include linear programming (LP) models, regression models, dimensionality reduction models, ensemble learning models, reinforcement learning models, supervised learning models, unsupervised learning models, semi-supervised learning models, Bayesian models, decision tree models, linear classification models, artificial neural networks, association rule learning models, hierarchical clustering models, cluster analysis models, anomaly detection models, deep learning models, feature learning models, and combinations thereof. For example, one or more machine learning models described herein may embody a supervised deep learning neural network, and/or the like.

“Intrusion model” refers to any algorithmic, statistical, relational, and/or machine learning-based model that defines one or more aspects of an anomalous event based on processing data. In some embodiments, the data processed by an intrusion model includes historical system data that is known to be associated with historical anomalous activities, historical system data that is known to be unassociated with anomalous activity, and/or the like. In some embodiments, an intrusion model embodies a model configured to classify and describe intrusions to computing environments. For example, an intrusion model may embody an Adversarial Tactics, Techniques, and Common Knowledge (ATT&CK) model. In some embodiments, an intrusion model embodies model configured to associate system data with one or more intrusion phases. For example, an intrusion model may embody a classification model configured to associate system data with one or more phases of a cyber kill chain. In some embodiments, an intrusion model embodies a model configured to generate event data objects representative of one or more operations occurring on a computing environment. For example, an intrusion model may embody a diamond-based model configure to generate event data objects (“diamonds”) representative of operation instigators (e.g., potential perpetrators of anomalous activity), operation targets (e.g., potential victims of anomalous activity), affected infrastructure (e.g., elements of a computing environment or particular data of a computing environment being used to carry out the operation), and instigator capabilities (e.g., potential outcomes, impacts, consequences, and/or the like of the operation).

“Response action” refers to any operation, task, process, function, command, protocol and/or the like that may be performed by, applied to, or configured at a computing environment to reduce the vulnerability of the computing environment to one or more anomalous activities. In some embodiments, the response action includes implementing one or more security protocols at the computing environment. For example, based on one or more predictive outputs, a security protocol of enabling multi-factor and/or location-based user authentication may be implemented at a computing environment. In some embodiments, the response action includes preventing communication between a computing environment and one or more computing devices. For example, a response action may include updating a blocklist to include device identifiers and/or the like for computing devices associated with anomalous activity detected in one or more operations. In some embodiments, the response action includes generating and provisioning alerts to administrators of a computing environment. In some embodiments, the response action includes disabling one or more user accounts, adjusting one or more user account settings (e.g., authentication settings, credential refresh or reset, and/or the like), or reporting anomalous activity to one or more computing devices associated with a user account.

“Security protocol” refers to any change to a computing environment that may be implemented at a computing environment to reduce the vulnerability of the computing environment to one or more anomalous activities. In some embodiments, the security protocol includes adjustments to or implementations of one or more rules, processes, settings, programs, and/or the like. In one example, a security protocol may include adjustments to one or more aspects of real-time monitoring of operations occurring on the computing environment to better detect anomalous activities. In another example, a security protocol may include adjustments to account authentication policies (or introduce new account authentication policies) to reduce vulnerability of user accounts to theft, takeover, exploitation, and/or the like. In another example, a security protocol may include one or more data management processes to reduce vulnerability of the computing environment to unauthorized data manipulation. In still another example, a security protocol may include one or more communication control processes to reduce vulnerability of the computing environment to network intrusion.

### Example Systems and Apparatuses of the Disclosure

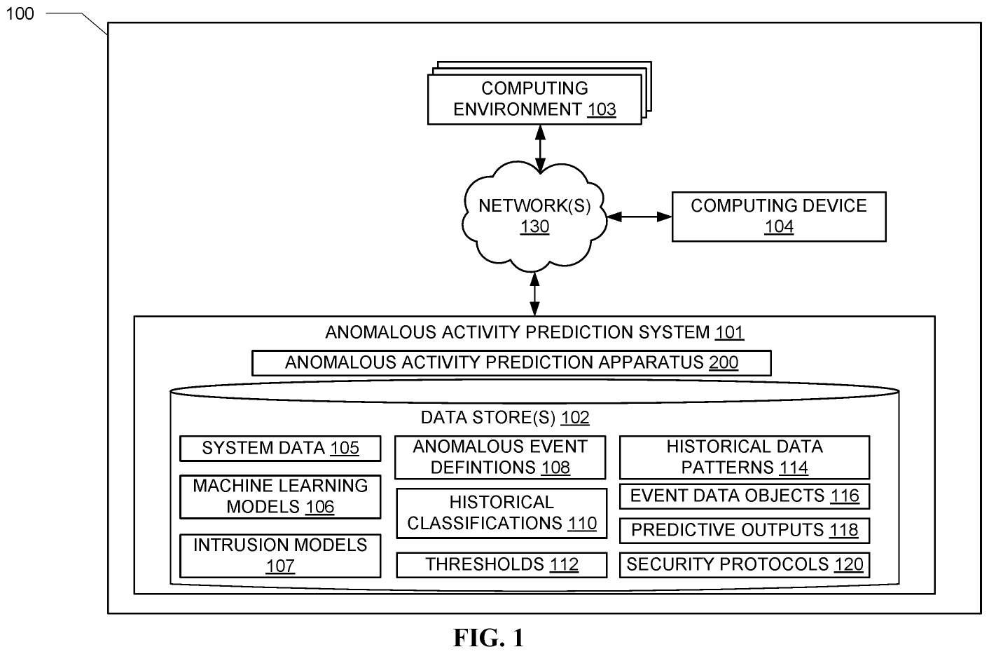

FIG. 1 illustrates a block diagram of a system that may be specially configured within which embodiments of the present disclosure may operate. Specifically, FIG. 1 depicts an example system 100. As illustrated, the system 100 includes an anomalous activity prediction system 101, one or more computing environments 103, and one or more computing devices 104. In some embodiments, a computing device 104 is associated with an administrator of a computing environment 103. Additionally, or alternatively, in some embodiments, a computing device 104 refers to any computing device configured to communicate with the computing environment 103, including computing devices associated with potential anomalous activity occurring in one or more operations of the computing environment 103. In various embodiments, the computing environment 103 includes any computing system, platform, application, service, database, and/or the like.

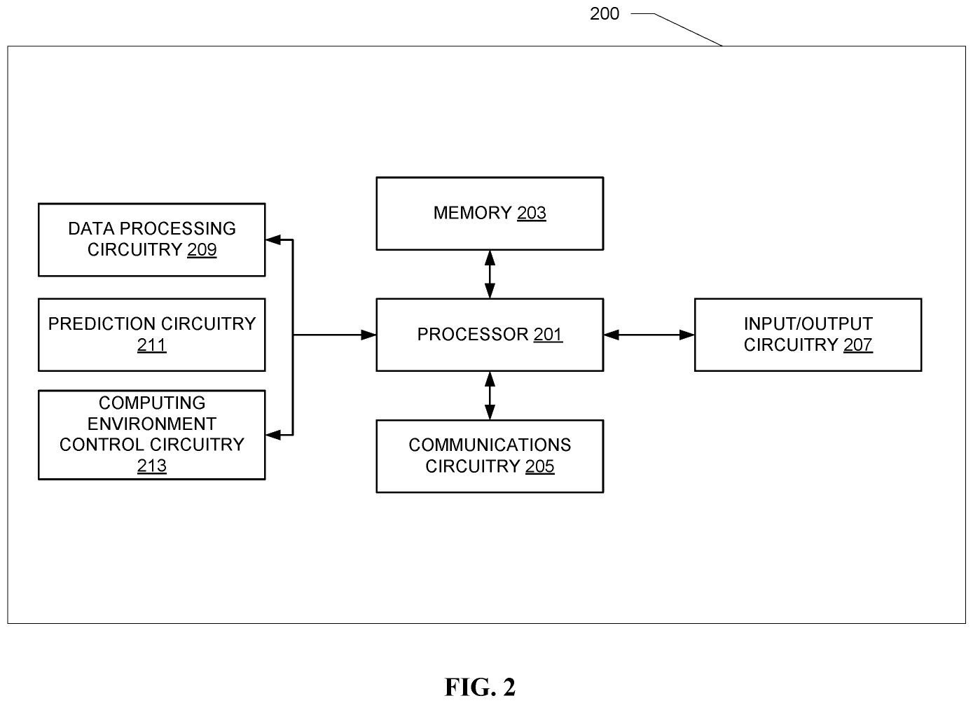

In some embodiments, the anomalous activity prediction system 101 is embodied as, or includes one or more of, an anomalous activity detection apparatus 200 (e.g., as further illustrated in FIG. 2 and described herein). Various applications and/or other functionality may be executed in the anomalous activity prediction system 101 and/or anomalous activity prediction apparatus 200 according to various embodiments. In some embodiments, the anomalous activity prediction apparatus 200 is embodied as a software program installed in a computing environment 103. For example, functions and operations of the anomalous activity prediction apparatus 200 may be automatically invoked and executed at the computing environment 103 to detect and respond to anomalous activity in one or more operations occurring at the computing environment 103. Alternatively, the anomalous activity prediction apparatus 200 may be external to a computing environment 103 and configured to obtain system data 105 from one or more computing environments 103.

In some embodiments, the computing environment 103 includes any number of computing systems, platforms, applications, networks, and/or the like. In some embodiments, a computing environment 103 refers to a plurality of computing devices 104. For example, the computing environment 103 may include a plurality of computing devices 104 that are associated with the same organization. In some embodiments, the computing device 104 includes a personal computer, laptop, smartphone, tablet, Internet-of-Things enabled device, smart home device, virtual assistant, alarm system, workstation, work portal, and/or the like. A computing device 104 may include devices associated with users of a computing environment 103. Additionally, or alternatively, in some embodiments, a computing device 104 includes devices that communicate with the computing environment 103, where the devices may be operated by perpetrators or instigators of anomalous activity at the computing environment 103. Additionally, or alternatively, in some embodiments, a computing device 104 includes devices associated with one or more administrators of a computing environment 103. In some embodiments, the administrator or the computing device 104 of the administrator may possess privileges to respond to anomalous activity by approving the implementation of security protocols 120 or other response actions respective to a computing environment 103.

In some embodiments, the anomalous activity prediction system 101 includes, but is not limited to, the one or more anomalous activity prediction apparatuses 200 and one or more data stores 102. The various data in the data store 102 may be accessible to one or more of the anomalous activity prediction system 101, the anomalous activity prediction apparatus 200, and a computing device 104, where the computing device 104 is associated with an administrator of the computing environment 103. For example, the computing device 104 may access system data 105, anomalous event definitions 108, and/or the like, in response to receiving an alert from the anomalous activity prediction system 101. The data store 102 may be representative of a plurality of data stores 102 as can be appreciated. The data stored in the data store 102, for example, is associated with the operation of the various applications, apparatuses, and/or functional entities described herein. The data stored in the data store 102 may include, for example, system data 105, machine learning models 106, intrusion models 107, anomalous event definitions 108, historical classifications 110, thresholds 112, historical data patterns 114, event data objects 116, predictive outputs 118, and security protocols 120.

In some embodiments, the computing environment 103 and/or computing device 104 is/are communicable with the anomalous activity prediction system 101. In some embodiments, the anomalous activity prediction system 101, the computing environment 103, and/or the computing device 104 are communicable over one or more communications network(s), for example the communications network(s) 130.

In some embodiments, the apparatus 200 is configured to obtain data associated with one or more computing environments 103 and process the data using a plurality of intrusion models 107 to define historical classifications 110. For example, the apparatus 200 may obtain data associated with historical incidents of anomalous activity in one or more operations that occurred on a computing environment 103. The apparatus 200 may process the data through a first intrusion model 107 configured to generate or predict anomalous activity data patterns based at least in part on the data, a second intrusion model 107 configured to map data the to one or more intrusion phases, and a third intrusion model 107 configured to generate one or more event data objects representative of respective operations. The apparatus 200 may integrate the outputs of the first, second, and third intrusion models 107 to obtain historical classifications 110 of the data. The apparatus 200 may generate one or more anomalous event definitions 108 respective to the historical incidents of anomalous activity based at least in part on the historical classifications 110.

In some embodiments, the data associated with the computing environment 103 includes historical system data 105. In some embodiments, a first portion of the historical system data 105 is labeled as being associated with historical anomalous activity on the computing environment. In some embodiments, a second portion of the historical system data 105 is labeled as being unassociated with anomalous activity such that the second portion of the historical system data 105 is representative of nominal activity in the computing environment 103. In some embodiments, the historical classifications 110 include a first portion associated with anomalous activity and a second portion associated with nominal activity. The historical classifications 110 may be representative of historical operations occurring on the computing environment 103 and may indicate whether a respective operation is associated with anomalous activity or nominal activity. In some embodiments, the apparatus 200 defines one or more aspects of anomalous event definitions 108 based on the historical classifications 110. In some embodiments, based on training data including the first portion of historical classifications 110, the second portion of historical classifications 110, and/or one or more anomalous event definitions 108, the apparatus 200 trains one or more machine learning models 106 to predict a predicted output indicative of whether system data indicates an aspect of one or more anomalous event definitions 108.

In some embodiments, the apparatus 200 monitors system data 105 associated with one or more operations occurring (or which have occurred) in one or more computing environments 103. In some embodiments, the system data 105 is associated with historical operations that have occurred in the computing environment 103. Additionally, or alternatively, in some embodiments, the system data 105 includes or embodies live data that is associated with one or more operations currently occurring in the computing environment 103. As one example, the apparatus 200 may receive logs of actions, operations, tasks, commands, queries, requests, and/or the like that are executed by the computing environment 103. In some embodiments, the system data 105 includes network data, which may embody any data communicated to, within, or from a computing environment 103. For example, the apparatus 200 may collect or receive data indicative of communications between the computing environment 103 and one or more computing devices 104. The data indicative of communications may include outputs provided by the computing environment 103 to the computing device 104, such as information about network resources, user data (e.g., credentials, password hashes, clipboard data, cookie data, keys, tokens, and/or the like), query results, settings, files, program versions, and/or the like.

In some embodiments, the system data 105 includes device data, which may embody any data that identifies or is received from a computing device 104. For example, the device data may include inputs provided by a computing device 104 to the computing environment 103, such as commands or requests to install or modify programs, access or manipulate stored data, adjust computing environment settings, and/or the like. As another example the device data may include an international mobile equipment identifier (IMEI) number, serial number, media access control (MAC) address, internet protocol (IP) address, device location, network provider identifier, and/or the like.

In some embodiments, the apparatus 200 generates and trains machine learning models 106 based on historical classifications 111 of data processed by a plurality of models 107. In various embodiments, the machine learning model 106 is configured to generate a predictive output 118 indicative of whether system data 105 indicates one or more aspects of an anomalous event definition 108 (e.g., as defined by the plurality of intrusion models 107). For example, the machine learning model 106 may embody a deep learning neural network configured to predict whether system data 105 indicates one or more aspects of an anomalous event definition. In some embodiments, the apparatus 200 trains the machine learning model 106 using supervised learning techniques that leverage historical classifications 111 as the training data such that the machine learning model 106 learns parameters for predicting whether one or more portions of system data 105 are associated with one or more aspects of an anomalous event definition 108. For example, the apparatus 200 may perform supervised training of a deep neural network model based at least in part on classifications of historical data processed by a plurality of intrusion models 107.

In some embodiments, the anomalous event definition 108 embodies a knowledge base for a particular type or class of anomalous activity. In various embodiments, the anomalous event definition 108 integrates information from various intrusion models 107. For example, the anomalous event definition 108 may integrate historical data patterns from a first intrusion model, associations between system data with one or more intrusion phases from a second intrusion model, and event data objects from a third intrusion model. In some embodiments, an anomalous event definition 108 an identifier for an associated anomalous event. In some embodiments, based on the identifier, the apparatus 200 obtains one or more security protocols 120, response actions, and/or the like that may be implemented to reduce vulnerability of the computing environment 103 to the anomalous activity in an operation (e.g., as defined by the anomalous event definition 108). For example, the apparatus 200 may query one or more databases of security protocols 120, response actions, and/or the like based on an identifier to obtain security protocols, response actions, and/or the like that are associated with mitigating particular anomalous activity.

In some embodiments, an anomalous event definition 108 may include historical data patterns 114 that have been observed in a previous anomalous event. In some embodiments, the historical data patterns 114 are provided by a first intrusion model 107, and the first intrusion model 107 is configured to compare system data 105 (e.g., historical system data, live data, and/or the like) to the historical patterns 114 to generate output indicative of whether an operation represented by the system data 105 is associated with one or more historical data patterns 114. For example, the first intrusion model 107 may include a database of historical anomalous event patterns, definitions, and/or the like, such as an Adversarial Tactics, Techniques, and Common Knowledge (ATT&CK) knowledge base. The first intrusion model 107 may be configured to map system data 105 to one or more entries of the database such that the mapping may be used by a machine learning model 106 to predict whether the system data 105 indicates one or more aspects of an anomalous event definition 108.

In some embodiments, an anomalous event definition 108 includes associations between historical system data 105 and one or more intrusion phases. For example, the anomalous event definition 108 may define an anomalous activity respective to phases of a cyber kill chain (e.g., reconnaissance, weaponization, delivery, exploitation, installation, command and control, and actions on objectives). In some embodiments, a second intrusion model 107 is configured to classify historical data from previous anomalous events into one or more intrusion phases. In some embodiments, the second intrusion model is further configured to associate an operation with one or more intrusion phases determined based at least in part on system data 105 that is representative of the operation. In some embodiments, output of the second intrusion model 107 (e.g., association between an operation and an intrusion phase) is provided as input to a first intrusion model 107 such that the first intrusion model 107 may associate the system data 105 with one or more historical data patterns 114 based at least in part on the output of the second intrusion model.

In some embodiments, an anomalous event definition 108 includes one or more historical event data objects 116. In various embodiments, an event data object 116 represents one or more aspects of a historical anomalous event or an operation occurring in a computing environment 103. For example, a historical event data object 116 may be representative of known perpetrators of anomalous activity, known victims of anomalous activity, computing environment infrastructure affected by or that has been used to facilitate anomalous activity, and outcomes, impacts, consequences, and/or the like of the anomalous activity. As another example, an event data object 116 generated based at least in part on system data 105 may be representative of potential perpetrators or instigators of an operation, potential targets of the operation (e.g., user accounts, particular stored data, performance of particular actions, and/or the like), infrastructure associated with performance of the operation, and capabilities of the operation to affect the computing environment 103 in which the operation is occurring. In some embodiments, a third intrusion model 107 is configured to generate event data objects 116 including event data objects based at least in part on system data 105 and historical data objects based at least in part on data associated with previous anomalous events. In some embodiments, the event data object 116 embodies a diamond representation of intrusion analysis, where a third intrusion model 107 is configured to generate the diamond representation of intrusion analysis based on system data 105 or historical data associated with previous anomalous events.

In some embodiments, the apparatus 200 compares a system data-derived event data object 116 to one or more anomalous event definitions 108 (e.g., which may include historical event data objects) to define one or more aspects of an anomalous event. For example, the apparatus 200 may generate and train a machine learning model 106 to generate a predictive output 118 based on whether one or more portions of system data 105 indicate one or more aspects of an anomalous event as defined by a plurality of intrusion models 107. The one or more aspects of the anomalous event may defined at least in part on comparisons between an event object representative of the system data and respective historical event data objects from a plurality of anomalous event definitions 108.

In some embodiments, the apparatus 200 performs response actions to reduce vulnerability of a computing environment 103 to anomalous activity in an operation, where the operation may be an operation that previously occurred in the computing environment, is currently occurring in the computing environment, or may occur in the computing environment in the future. In some embodiments, the apparatus 200 determines a response action to perform based on a predictive output 118. For example, where a predictive output 118 indicates that system data 105 is associated with a particular anomalous event definition 108, the apparatus 200 may obtain one or more response actions from the particular anomalous event definition 108 or one or more intrusion models 107. In some embodiments, a response action includes the apparatus 200 generating and provisioning an alert indicative of an operation to a computing device 104 associated with an administrator of a computing environment 103. In some embodiments, a response action includes the apparatus 200 suspending or blocking the operation. In some embodiments, a response action includes the apparatus disabling one or more user accounts of the computing environment that are associated with performance of the operation or targeted by the operation.

In some embodiments, a response action includes the apparatus 200 disabling communication access of one or more computing devices 104 to the computing environment 103. For example, the apparatus 200 may add device data identifying a computing device 104 to a blocklist such that communications, commands, request, and/or the like originating from the computing device 104 are ignored or blocked. In some embodiments, a response action includes the apparatus 200 retraining a machine learning model 106 based at least in part on system data 105. For example, in response to determining that a portion of system data 105 indicates an aspect of anomalous event, the apparatus 200 may retrain a machine learning model 106 based one or more classifications of the system data generated by a plurality of intrusion models 107. In some embodiments, the response action includes the apparatus 200 updating an anomalous event definition 108 based on system data 105, or a portion of the system data 105 determined to be associated with a corresponding anomalous event.

In some embodiments, the response action includes the apparatus 200 generating one or more security protocols 120 to reduce vulnerability of the computing environment to current and future anomalous activity occurring in an operation. In some embodiments, the apparatus 200 provisions the security protocol 120 to a computing device 104 associated with an administrator of the computing environment 103 such that the administrator is informed of optimal security practices in real-time. Alternatively, or additionally, in some embodiments, the apparatus 200 automatically, or in response to administrator input, implements the security protocol at the computing environment 103. In some embodiments, the apparatus 200 generates the security protocol based at least in part on an anomalous event definition 108. For example, an anomalous event definition 108 may indicate historical techniques performed to mitigate previous instances of anomalous activity. The apparatus 200 may query the anomalous event definition 108 based on the aspect of the anomalous event indicated by system data 105, where the query returns one or more historical security protocols 120 that may be implemented at the computing environment associated with the system data 105.

In some embodiments, the apparatus 200 generates and trains a machine learning model 106 to generate a predictive output 118 indicative of one or more security protocols 120. For example, the machine learning model 106 may be configured to predict a respective likelihood of a plurality of possible security protocols 120 to reduce vulnerability of a computing environment to anomalous activity in an operation. The machine learning model 106 may be trained on historical associations of the possible security protocols with one or more anomalous events as defined by one or more intrusion models 107. In some embodiments, the predictive output 118 includes respective likelihood scores for a plurality of possible security protocols 120 such that the apparatus 200 may generate a ranking of the possible security protocols 120 based on the likelihood scores and select one or more top-ranked security protocols for recommendation to an administrator or immediate implementation at the computing environment.

In some embodiments, a security protocol 120 defines one or more adjustments to account authentication policies of the computing environment. In some embodiments, the adjustment includes implementing an account lockout protocol. For example, an account may be automatically locked in response to a threshold number of failed login attempts, password resets, and/or the like. In some embodiments, the adjustment includes implementing multifactor authentication protocols for one or more operations. For example, multifactor authentication protocols may be implemented for user login, accessing or manipulating data, changing settings, and/or the like. In some embodiments, the adjustment includes implementing a credential management protocol. For example, the credential management protocol may establish threshold intervals for updating credentials, hashing passwords or other credentials, encrypting credentials, and/or the like. In some embodiments, a security protocol defines one or more adjustments to subsequent real-time monitoring of operations occurring on a computing environment 103. For example, the adjustment may be associated with changes to, or causing the implementation of, application log monitoring, command monitoring, user account monitoring, and/or the like.

In some embodiments, the security protocol 120 defines one or more data management processes to reduce vulnerability of the computing environment 103 to unauthorized data manipulation. In some embodiments, the data management process includes implementing periodic backups of data store in the computing environment 103. In some embodiments, the data management process includes monitoring for modifications to data, including excess data modification, atypical data modifications, unauthorized or unauthorized data manipulation or access, and/or the like. In some embodiments, the data management process includes implementing or adjusting parameters of data encryption. For example, the data management process may include updating random values, salt data, or noise data for seeding or performing encryption. As another example, the data management process may include transitioning from a current encryption algorithm to an alternative, more secure encryption algorithm. In some embodiments, the security protocol 120 defines one or more communication control processes to reduce vulnerability of the computing environment 103 to network intrusion.

In some embodiments, the communication control process includes implementing signature verification, public-private key infrastructure, and/or the like for verifying authenticity of communications received at the computing environment 103. In some embodiments, the communication control process includes communication content filtering to identify and block communications including content that may enable anomalous activity at the computing environment 103. In some embodiments, the communication control process includes implementing network traffic flow monitoring to determine if current patterns of network traffic demonstrate similarity to historical patterns associated with anomalous activity.

In some embodiments, the apparatus 200 compares a predictive output 118 to one or more thresholds 112 to determine whether to perform one or more response actions. For example, a threshold 112 may embody an anomalous event threshold for determining whether a predictive output 118 indicates that system data 105 (e.g., upon which the predictive is based) is associated with one or more anomalous event definitions 108. The apparatus 200 may determine that the predictive output 118 meets the anomalous event threshold and, in response to the determination, perform one or more response actions to reduce vulnerability of a computing environment to anomalous activity in an operation represented by the system data 105.

It should be appreciated that the communications network 130 in some embodiments is embodied in any of a myriad of network configurations. In some embodiments, the communications network 130 embodies a public network (e.g., the Internet). In some embodiments, the communications network 130 embodies a private network (e.g., an internal, localized, and/or closed-off network between particular devices). In some other embodiments, the communications network 130 embodies a hybrid network (e.g., a network enabling internal communications between particular connected devices and external communications with other devices). The communications network 130 in some embodiments may include one or more base station(s), relay(s), router(s), switch(es), cell tower(s), communications cable(s) and/or associated routing station(s), and/or the like. In some embodiments, the communications network 130 includes one or more user-controlled computing device(s) (e.g., a user owner router and/or modem) and/or one or more external utility devices (e.g., Internet service provider communication tower(s) and/or other device(s)).

Each of the components of the system communicatively coupled to transmit data to and/or receive data from one another over the same or different wireless or wired networks embodying the communications network 130. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network 130, the various embodiments are not limited to this particular architecture. In other embodiments, one or more computing entities share one or more components, hardware, and/or the like, or otherwise are embodied by a single computing device such that connection(s) between the computing entities are over the communications network 130 are altered and/or rendered unnecessary.

The computing device 104 includes one or more computing device(s) accessible to an end user, which may embody any user of a computing environment or, in particular embodiments, an administrator of a computing environment. In some embodiments, the computing device 104 includes a personal computer, laptop, smartphone, tablet, Internet-of-Things enabled device, smart home device, virtual assistant, alarm system, workstation, work portal, and/or the like. The computing device 104 may include one or more displays, one or more visual indicator(s), one or more audio indicator(s) and/or the like that enables output to a user associated with the computing device 104. For example, in some embodiments, the anomalous activity prediction system 101 provides a graphical user interface (GUI) for rendering on the display. In another example, the anomalous activity prediction system 101 may provide an alert to the computing device 104, where the alert indicates a predictive output 118 or other indication that an operation is predicted to be associated with an anomalous event definition. In another example, the anomalous activity prediction system 101 may provision one or more security protocols 120 to the computing device 104.

FIG. 2 illustrates a block diagram of an example apparatus that may be specially configured in accordance with at least some example embodiments of the present disclosure; Specifically, FIG. 2 depicts an example anomalous activity prediction apparatus 200 (“apparatus 200”) specially configured in accordance with at least some example embodiments of the present disclosure. In some embodiments, the anomalous activity prediction system 101 and/or a portion thereof is embodied by one or more system(s), such as the apparatus 200 as depicted and described in FIG. 2. The apparatus 200 includes processor 201, memory 203, communications circuitry 205, input/output circuitry 207, data processing circuitry 209, prediction circuitry 211, and computing environment control circuitry 213. In some embodiments, the apparatus 200 is configured, using one or more of the processor 201, memory 203, communications circuitry 205, input/output circuitry 207, data processing circuitry 209, prediction circuitry 211, and/or computing environment control circuitry 213, to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, modifying, restoring, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Additionally, or alternatively, in some embodiments, other elements of the apparatus 200 provide or supplement the functionality of another particular set of circuitry. For example, the processor 201 in some embodiments provides processing functionality to any of the sets of circuitry, the memory 203 provides storage functionality to any of the sets of circuitry, the communications circuitry 205 provides network interface functionality to any of the sets of circuitry, and/or the like.

In some embodiments, the processor 201 (and/or co-processor or any other processing circuitry assisting or otherwise associated with the processor) is/are in communication with the memory 203 via a bus for passing information among components of the apparatus 200. In some embodiments, for example, the memory 203 is non-transitory and may include, for example, one or more volatile and/or non-volatile memories. In other words, for example, the memory 203 in some embodiments includes or embodies an electronic storage device (e.g., a computer readable storage medium). In some embodiments, the memory 203 is configured to store information, data, content, applications, instructions, or the like, for enabling the apparatus 200 to carry out various functions in accordance with example embodiments of the present disclosure. In some embodiments, the memory 203 is embodied as, or communicates with, a data store 102 as shown in FIG. 1 and described herein.

The processor 201 may be embodied in a number of different ways. For example, in some example embodiments, the processor 201 includes one or more processing devices configured to perform independently. Additionally, or alternatively, in some embodiments, the processor 201 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 201 is configured to execute instructions stored in the memory 203 or otherwise accessible to the processor. Additionally, or alternatively, the processor 201 in some embodiments is configured to execute hard-coded functionality. As such, whether configured by hardware or software methods, or by a combination thereof, the processor 201 represents an entity (e.g., physically embodied in circuitry) capable of performing operations according to an embodiment of the present disclosure while configured accordingly. Additionally, or alternatively, as another example in some example embodiments, when the processor 201 is embodied as an executor of software instructions, the instructions specifically configure the processor 201 to perform the algorithms embodied in the specific operations described herein when such instructions are executed.

As one particular example embodiment, the processor 201 is configured to perform various operations associated with detecting and responding to anomalous activity in one or more operations of one or more computing environments, including training machine learning models, monitoring computing environments, generating predictive output using machine learning models, processing data using intrusion models, and performing development phase actions and/or runtime phase actions.

In some embodiments, the apparatus 200 includes input/output circuitry 207 that provides output to the user and, in some embodiments, to receive an indication of a user input. For example, the input/output circuitry 207 provides output to and receives input from one or more computing devices 104, one or more computing environments 103, and/or the like. In another example, the input/output circuitry 207 provides output to one or more computing devices 104, one or more computing environments 103, and/or the like. In some embodiments, the input/output circuitry 207 is in communication with the processor 201 to provide such functionality. The input/output circuitry 207 may comprise one or more user interface(s) and in some embodiments includes a display that comprises the interface(s) rendered as a web user interface, an application user interface, a user device, a backend system, or the like. In some embodiments, the input/output circuitry 207 also includes a keyboard, a mouse, a joystick, a touch screen, touch areas, soft keys a microphone, a speaker, and/or other input/output mechanisms. The processor 201 and/or input/output circuitry 207 comprising the processor may be configured to control one or more functions of one or more user interface elements through computer program instructions (e.g., software and/or firmware) stored on a memory accessible to the processor (e.g., memory 203, and/or the like). In some embodiments, the input/output circuitry 207 includes or utilizes a user-facing application to provide input/output functionality to a computing device 104 and/or other display associated with a user.

In some embodiments, the apparatus 200 includes communications circuitry 205. The communications circuitry 205 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 205 includes, for example, a network interface for enabling communications with a wired or wireless communications network, such as the network 130 shown in FIG. 1 and described herein. Additionally, or alternatively in some embodiments, the communications circuitry 205 includes one or more network interface card(s), antenna(s), bus(es), switch(es), router(s), modem(s), and supporting hardware, firmware, and/or software, or any other device suitable for enabling communications via one or more communications network(s). Additionally, or alternatively, the communications circuitry 205 includes circuitry for interacting with the antenna(s) and/or other hardware or software to cause transmission of signals via the antenna(s) or to handle receipt of signals received via the antenna(s). In some embodiments, the communications circuitry 205 enables transmission to and/or receipt of data from data stores 102, computing environments 103, computing devices 104, and/or other external computing devices in communication with the apparatus 200. In some embodiments, the communications circuitry 205 enables generation and transmission of alerts, notifications comprising security protocols, and/or the like.

The data processing circuitry 209 includes hardware, software, firmware, and/or a combination thereof, that supports various functionality associated with monitoring system data associated with one or more operations on one or more computing environments 103. Additionally, or alternatively, in some embodiments, the data processing circuitry 209 includes hardware, software, firmware, and/or any combination thereof, that processes data, such as historical anomalous activity data, through a plurality of intrusion models 107. In some embodiments, the data processing circuitry 209 includes a separate processor, specially configured field programmable gate array (FPGA), and/or a specially programmed application specific integrated circuit (ASIC).

The prediction circuitry 211 includes hardware, software, firmware, and/or a combination thereof, that supports various functionality associated with training and executing machine learning models to generate predictive output indicative of whether system data is associated with one or more anomalous event definitions. In some embodiments, the prediction circuitry 211 includes hardware, software, firmware, and/or a combination thereof, that configure machine learning models to generate the predictive output based on whether a portion of system data indicates an aspect of an anomalous event as defined by a plurality of intrusion detection model. In some embodiments, the prediction circuitry 211 includes hardware, software, firmware, and/or a combination thereof, that train machine learning models using historical classifications of data processed using the plurality of intrusion model. In some embodiments, the prediction circuitry 211 includes a separate processor, specially configured field programmable gate array (FPGA), and/or a specially programmed application specific integrated circuit (ASIC).

The computing environment control circuitry 213 includes hardware, software, firmware, and/or a combination thereof, that supports various functionality associated with performing actions in response to predictive output and to reduce vulnerability of one or more computing environment 103 to anomalous activity in one or more operations occurring in the same or other computing environments 103. In some embodiments, the computing environment control circuitry 213 includes hardware, software, firmware, and/or a combination thereof, that perform development phase actions, runtime phase actions, and/or the like, as described herein. In some embodiments, the data computing environment control circuitry 213 includes a separate processor, specially configured field programmable gate array (FPGA), and/or a specially programmed application specific integrated circuit (ASIC).

Additionally, or alternatively, in some embodiments, two or more of the processor 201, memory 203, communications circuitry 205, input/output circuitry 207, data processing circuitry 209, prediction circuitry 211, and/or computing environment control circuitry 213 are combinable. Additionally, or alternatively, in some embodiments, one or more of the sets of circuitry perform some or all of the functionality described associated with another component. For example, in some embodiments, two or more of the sets of circuitry 201-213 are combined into a single module embodied in hardware, software, firmware, and/or a combination thereof. Similarly, in some embodiments, one or more of the sets of circuitry, for example the data processing circuitry 209, the prediction circuitry 211, and/or the computing environment control circuitry 213 is/are combined with the processor 201, such that the processor 201 performs one or more of the operations described above with respect to each of these sets of circuitry 207-213.

### EXAMPLE WORKFLOWS OF THE DISCLOSURE

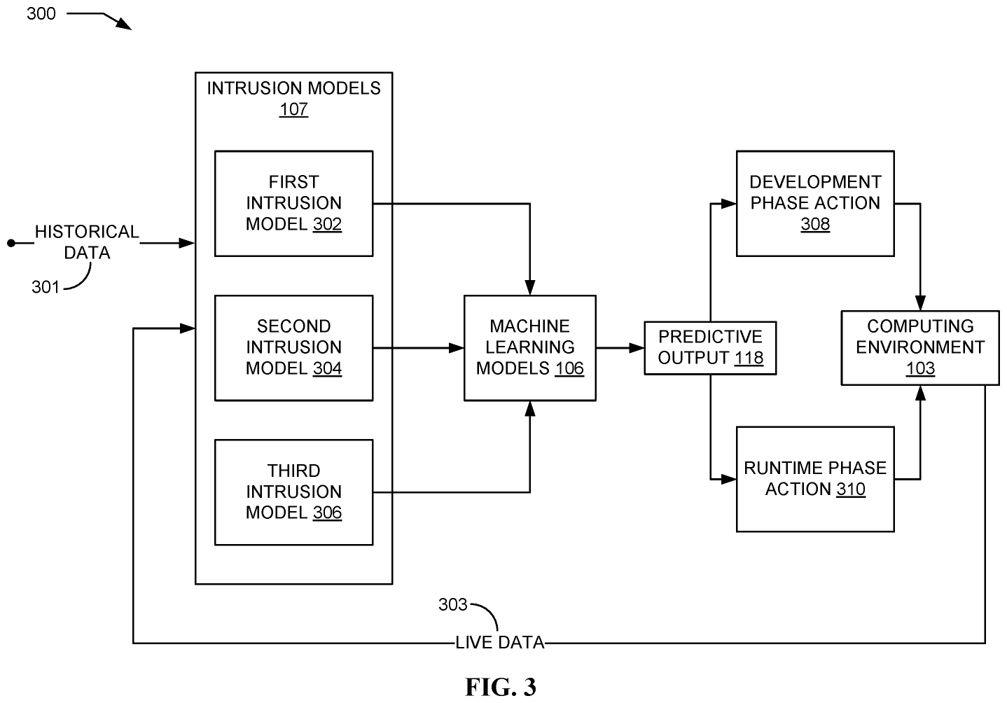

Having described example systems and apparatuses in accordance with embodiments of the present disclosure, example workflows and architectures of data in accordance with the present disclosure will now be discussed. In some embodiments, the systems and/or apparatuses described herein maintain data environment(s) that enable the workflows in accordance with the data architectures described herein. For example, in some embodiments, the systems and/or apparatuses described herein function in accordance with the workflows depicted in and described herein with respect to FIG. 3 are performed via the anomalous activity prediction system 101 embodied by an apparatus 200 (and/or a computing environment 103 including software that embodies functionality of the apparatus 200 as described herein).

FIG. 3 illustrates an example workflow 300 in accordance with at least some example embodiments of the present disclosure. Specifically, FIG. 3 depicts a flow of data between the various computing elements depicted and described in FIG. 1. In some embodiments, the workflow 300 is performed by the anomalous activity prediction system 101 as embodied by an anomalous activity prediction apparatus 200. As illustrated, in some embodiments, the workflow 300 includes processing system data (embodied as at least one of historical data 301 or live data 303) using a plurality of intrusion models. In some embodiments, a first intrusion model 302 embodies an ATT&CK framework configured to classify anomalous activities to generate and convey respective historical patterns associated with the anomalous activities. In some embodiments, a second intrusion model 304 embodies a phase-structured model configured to define anomalous activity respective to phases of a cyber kill chain such that response actions for reducing vulnerability to anomalous activity may be layered to protect a computing environment at each of one or more phases of an anomalous event. In some embodiments, a third intrusion model 306 embodies a framework for defining aspects of anomalous activity to support analysis of system data and structuring of response actions for mitigating anomalous events. In some embodiments, the third intrusion model 306 generates a diamond representation of an anomalous activity, where vertices of the diamond representation define, respectively, adversaries of a computing environment (e.g., perpetrators or instigators of anomalous events), victims (e.g., targeted computing environments or aspects thereof), infrastructure for facilitating the anomalous activity, and capabilities of adversaries as enabled by the anomalous activity occurring in the computing environment. In some embodiments, the diamond representation includes metadata including timestamps, intrusion phases, activity results, directionality of communication or actions (e.g., bidirectional, unidirectional from the computing environment, unidirectional to the computing environment, and/or the like), methodology, resources, and/or the like.

In some embodiments, respective outputs of a first intrusion model 302, second intrusion model 304, and third intrusion model 306 are used to generate and/or update a plurality of anomalous event definitions using one or more machine learning models 106. For example, the workflow 300 may include processing the respective outputs of the first, second, and third intrusion models using a first machine learning model 106, where an output of the first machine learning model 106 includes respective anomalous event definitions for one or more historical anomalous events. In some embodiments, the workflow 300 includes generating and/or retraining another machine learning model 106 based on the anomalous event definitions. For example, the workflow 300 may include training a second machine learning model to predict a predictive output 118 indicative of whether system data representative of an operation in a computing environment is associated with one or more anomalous event definitions.

In some embodiments, the workflow 300 includes generating predictive output 118 based at least in part on system data (e.g., historical data 301 and/or live data 303) and using the trained machine learning model 106. Additionally, or alternatively, in some embodiments, the workflow 300 includes performing one or more response actions based on the predictive output 118 to reduce vulnerability of a computing environment 103 to anomalous activity in one or more operations associated with the system data. For example, the workflow 300 may include performing one or more development phase actions 308 to generate security protocols 120, which be implemented at the computing environment to reduce vulnerability of the computing environment to the anomalous activity. As another example, the workflow 300 includes generating and performing one or more runtime phase actions 310 to block or suspend operations at the computing environment 103, generate and provision alerts, disable communication access of computing devices, disable user accounts, retrain machine learning models, generate new anomalous event definitions, and/or the like. In some embodiments, the workflow 300 is performed in a runtime mode such that only runtime phase actions 310 are performed. Alternatively, in some embodiments, the workflow 300 is performed in a development such that only development phase actions are performed. In some embodiments, the workflow 300 is performed such that development phase actions 308 and runtime phase actions 310 are performed to both reduce vulnerability of the computing environment to anomalous activity occurring therein in real-time and reconfigure the computing environment to reduce the likelihood of the anomalous activity occurring in the future and/or improve an ability to detect subsequent occurrences of the anomalous activity.

### EXAMPLE PROCESSES OF THE DISCLOSURE

Having described example systems and apparatuses, data architectures, workflows, and graphical representations in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

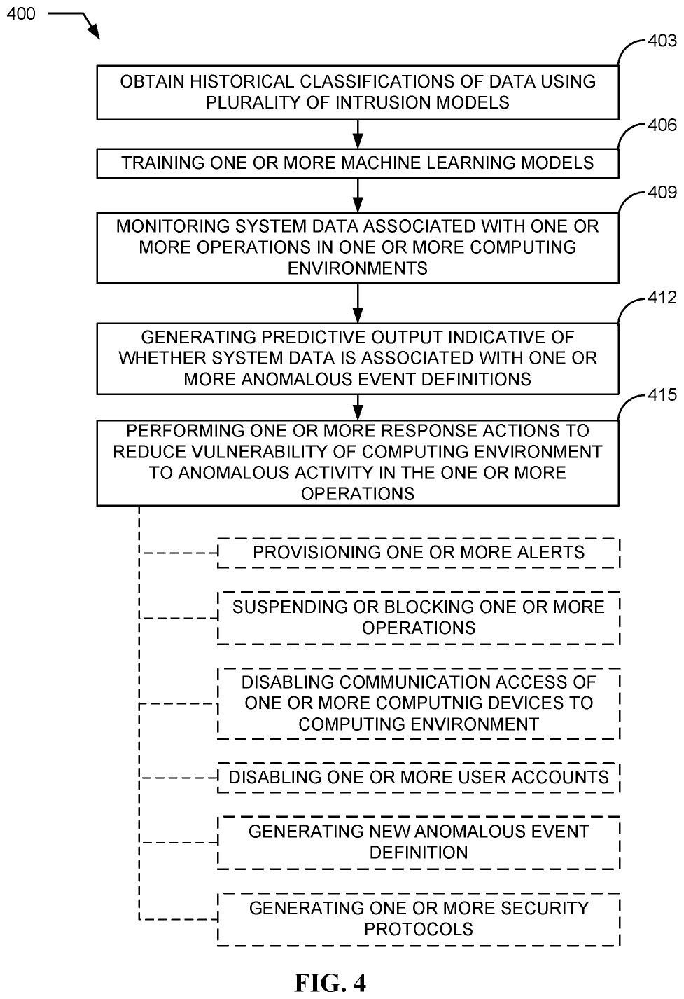

FIG. 4 illustrates a flowchart depicting operations of an example process for reducing vulnerability of a computing environment to anomalous activity in accordance with at least some example embodiments of the present disclosure. Specifically, FIG. 4 depicts operations of an example process 400. In some embodiments, the process 400 is embodied by computer program code stored on a non-transitory computer-readable storage medium of a computer program product configured for execution to perform the process as depicted and described. Additionally, or alternatively, in some embodiments, the process 400 is performed by one or more specially configured computing devices, such as the anomalous activity prediction apparatus 200 (“apparatus 200”) alone or in communication with one or more other component(s), device(s), system(s), and/or the like. In this regard, in some such embodiments, the apparatus 200 is specially configured by computer-coded instructions (e.g., computer program instructions) stored thereon, for example in the memory 203 and/or another component depicted and/or described herein and/or otherwise accessible to the apparatus 200, for performing the operations as depicted and described.

In some embodiments, the process 400 begins at operation 403. At operation 403, the apparatus 200 includes means such as the data processing circuitry 209, the prediction circuitry 211, the computing environment control circuitry 213, the communications circuitry 205, the input/output circuitry 207, the processor 201, and/or the like, or a combination thereof, that obtain historical classifications of data by processing the data using a plurality of intrusion models. For example, the apparatus 200 may generate historical classifications by processing current system data (e.g., live data), historical system data, and/or the like using a first intrusion model 107, a second intrusion model 107, and a third intrusion model 107. In some embodiments, the apparatus 200 generates a plurality of anomalous event definitions based on the historical classifications of data processed by the plurality of intrusion models 107. In some embodiments, each anomalous event definition is associated with a historical data pattern as defined by a first intrusion model.

At operation 406, the apparatus 200 includes means such as the data processing circuitry 209, the prediction circuitry 211, the computing environment control circuitry 213, the communications circuitry 205, the input/output circuitry 207, the processor 201, and/or the like, or a combination thereof, that train one or more machine learning models using the historical classifications. For example, the apparatus may train a machine learning model 106 using historical classifications of data processed by a plurality of intrusion models 107. In some embodiments, the apparatus 200 configures the machine learning model to generate predictive output 118 based on whether one or more portions of system data indicative an aspect of an anomalous event as defined by the plurality of intrusion models 107.

At operation 409, the apparatus 200 includes means such as the data processing circuitry 209, the prediction circuitry 211, the computing environment control circuitry 213, the communications circuitry 205, the input/output circuitry 207, the processor 201, and/or the like, or a combination thereof, that monitor system data associated with one or more operations occurring in one or more computing environments. For example, the apparatus 200 may monitor (e.g., and obtain) system data 105 associated with one or more operations occurring on a computing environment 103, where the system data 105 may include historical data, live data that is obtained from the computing environment 103 in real-time, and/or the like. In some embodiments, the apparatus 200 processes the system data using a plurality of intrusion models 107. In some embodiments, a first intrusion model is configured to generate an association between the operation and one or more historical data patterns based at least in part on a comparison of the system data to respective historical data patterns of a plurality of anomalous event definitions.

In some embodiments, a second intrusion model is configured to associate the operation with one or more intrusion phases determined based at least in part on the system data. In some embodiments, a third intrusion model is configured to generate an event data object representative of the operation based at least in part on the system data. In some embodiments, the apparatus 200 integrates the respective outputs of the plurality of intrusion models to generate a set of input data that may be processed by a machine learning model to predict a predictive outcome.

At operation 412, the apparatus 200 includes means such as the data processing circuitry 209, the prediction circuitry 211, the computing environment control circuitry 213, the communications circuitry 205, the input/output circuitry 207, the processor 201, and/or the like, or a combination thereof, that generate predictive output indicative of whether the system data is associated with one or more anomalous event definitions. For example, the apparatus 200 may generate, using a machine learning model 106 and based at least in part on the system data 105, a predictive output 118 indicative of whether the system data is associated with one or more anomalous event definitions 108. In some embodiments, the apparatus 200 trains the machine learning model using historical classifications of data processed using the plurality of intrusion models.

In some embodiments, the machine learning model is configured to generate configured to generate the predictive output based on whether one or more portions of the system data indicate an aspect of an anomalous event as defined by a plurality of intrusion detection models. In some embodiments, the apparatus 200 defines one or more aspects of the anomalous event based at least in part on the association between the operation and one or more historical data patterns. In some embodiments, the apparatus 200 defines one or more aspects of the anomalous event based at least in part on one or more intrusion phases. In some embodiments, the apparatus 200 defines one or more aspects of the anomalous event based at least in part on respective comparisons between the event data object representative of the operation and a plurality of anomalous event definitions (e.g., each of which may include one or more historical event data objects representative of historical anomalous events).

At operation 415, the apparatus 200 includes means such as the data processing circuitry 209, the prediction circuitry 211, the computing environment control circuitry 213, the communications circuitry 205, the input/output circuitry 207, the processor 201, and/or the like, or a combination thereof, that perform one or more response actions to reduce vulnerability of the computing environment to anomalous activity in the one or more operations occurring on the computing environment (or, alternatively or additionally, on another computing environment). For example, the apparatus 200 may perform one or more response actions to reduce vulnerability of the computing environment 103 to anomalous activity in the one or more operations occurring on the computing environment 103. In some embodiments, the apparatus 200 includes means such as the data processing circuitry 209, the prediction circuitry 211, the computing environment control circuitry 213, the communications circuitry 205, the input/output circuitry 207, the processor 201, and/or the like, or a combination thereof, that provision an alert to computing devices 104 of one or more administrators of the computing environment 103. In some embodiments, apparatus 200 includes means such as the data processing circuitry 209, the prediction circuitry 211, the computing environment control circuitry 213, the communications circuitry 205, the input/output circuitry 207, the processor 201, and/or the like, or a combination thereof, that suspend or block one or more operations occurring on the computing environment 103, such as the operation predicted to include anomalous activity.

In some embodiments, apparatus 200 includes means such as the data processing circuitry 209, the prediction circuitry 211, the computing environment control circuitry 213, the communications circuitry 205, the input/output circuitry 207, the processor 201, and/or the like, or a combination thereof, that disable communication access of one or more computing devices 104 to the computing environment 103. In some embodiments, the apparatus 200 includes means such as the data processing circuitry 209, the prediction circuitry 211, the computing environment control circuitry 213, the communications circuitry 205, the input/output circuitry 207, the processor 201, and/or the like, or a combination thereof, that disable one or more user accounts of the computing environment 103. In some embodiments, the apparatus 200 includes means such as the data processing circuitry 209, the prediction circuitry 211, the computing environment control circuitry 213, the communications circuitry 205, the input/output circuitry 207, the processor 201, and/or the like, or a combination thereof, that generate and store a new anomalous event definition 108 based on the system data 105 and analyses thereof as performed by the plurality of intrusion models 107.

In some embodiments, the apparatus 200 includes means such as the data processing circuitry 209, the prediction circuitry 211, the computing environment control circuitry 213, the communications circuitry 205, the input/output circuitry 207, the processor 201, and/or the like, or a combination thereof, that generate one or more security protocols 120 for implementation at the computing environment 103. In some embodiments, the apparatus 200 provisions the security protocol 120 to the computing environment 103 and/or a computing device 104 associated with an administrator of the computing environment 103. In some embodiments, the apparatus 200 automatically, or in response to receipt of input, implements the security protocol 120 at the computing environment 103. In some embodiments, the apparatus 200 adjusts one or more account authentication policies of the computing environment 103. For example, the apparatus 200 may implement one or more account lockout protocols, one or more multifactor authentication protocols, one or more credential management protocols, and/or the like. In some embodiments, the apparatus adjusts the real-time monitoring of the computing environment. For example, the apparatus 200 may adjust or implement application log monitoring, command monitoring, user account monitoring, and/or the like.

In some embodiments, the apparatus 200 adjusts or implements one or more data management processes to reduce vulnerability of the computing environment to unauthorized data manipulation. For example, the apparatus 200 may adjust or implement processes for data backup, data modification monitoring, data encryption, and/or the like. In some embodiments, the apparatus 200 adjusts or implements one or more communication control process to reduce vulnerability of the at least one computing environment to network intrusion. For example, the apparatus 200 may adjust or implement signature verification protocols, communication content filtering, or network traffic flow monitoring.

### Conclusion

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
monitoring system data associated with at least one operation occurring in at least one computing environment;
predicting a predictive output, using at least one machine learning model and based at least in part on the system data, the predictive output indicative of whether the system data is associated with at least one of a plurality of anomalous event definitions, wherein the at least one machine learning model is i) configured to generate the predictive output based on whether at least a portion of the system data indicates an aspect of an anomalous event as defined by a plurality of intrusion detection models, and ii) wherein the at least one machine learning model is trained on historical classifications of data processed using the plurality of intrusion models; and
in response to the predictive output, performing at least one response action that reduces vulnerability of the at least one computing environment to anomalous activity in the at least one operation.

2. The method of claim 1, wherein:
the system data comprises at least one of network data or device data.

3. The method of claim 1, wherein:
performing the at least one response action comprises:
generating at least one alert comprising the system data and the at least one anomalous event definition; and
causing provision of the alert to at least one computing device associated with an administrator of the at least one computing environment.

4. The method of claim 1, wherein:
the system data comprises live data collected in real-time from the at least one computing environment.

5. The method of claim 4, wherein:
performing the at least one response action comprises suspending or blocking the at least one operation.

6. The method of claim 1, wherein:
performing the at least one response action comprises disabling communication access of at least one computing device to the at least one computing environment.

7. The method of claim 1, wherein:
performing the at least one response action comprises disabling a user account associated with the at least one operation occurring in the at least one computing environment.

8. The method of claim 1, wherein:
performing the at least one response action comprises retraining the at least one machine learning model based at least in part on the system data.

9. The method of claim 1, further comprising:
in response to the predictive output failing to match a respective anomalous event threshold for any of the plurality of abnormal event definitions:
generating a new anomalous event definition based at least in part on the system data and at least one classification of the system data from the plurality of intrusion models; and
storing the new anomalous event definition in a data store that comprises the plurality of anomalous event definitions.

10. An apparatus comprising at least one processor and at least one non-transitory memory having computer-coded instructions stored thereon that, in execution with at least one processor, cause the apparatus to:
monitor system data associated with at least one operation occurring in at least one computing environment;
predict a predictive output, using at least one machine learning model and based at least in part on the system data, the predictive output indicative of whether the system data is associated with at least one of a plurality of anomalous event definitions, wherein:
the at least one machine learning model is configured to generate the predictive output based on whether at least a portion of the system data indicates an aspect of an anomalous event as defined by a plurality of intrusion detection models; and
the at least one machine learning model is trained on historical classifications of data processed using the plurality of intrusion models; and
in response to the predictive output perform at least one response action that reduces vulnerability of the at least one computing environment to anomalous activity in the at least one operation.

11. The apparatus of claim 10, wherein:
the computer-code instructions, in execution with the at least one processor, further cause the apparatus to perform the at least one response action in response to determining the predictive output meets a respective anomalous event threshold for the at least one anomalous event definition.

12. The apparatus of claim 10, wherein:
each of the plurality of anomalous event definitions is associated with at least one historical data pattern; and
a first model of the plurality of intrusion detection models is configured to:
generate an association between the at least one operation and at least one historical data pattern based at least in part on a comparison of the system data to the respective historical data patterns, wherein the aspect of the anomalous event is defined based at least in part on the association between the at least one operation and the at least one historical data pattern.

13. The apparatus of claim 12, wherein:
a second model of the plurality of intrusion detection models is configured to associate the at least one operation with at least one of a plurality of intrusion phases determined based at least in part on the system data, wherein the aspect of the anomalous event is further defined based at least in part on the at least one of the plurality of intrusion phases.

14. The apparatus of claim 13, wherein:
a third model of the plurality of intrusion models is configured to generate an event data object representative of the at least one operation based at least in part on the system data; and
the aspect of the anomalous event is further defined based at least in part on respective comparisons between the event data object and the plurality of anomalous event definitions.

15. The apparatus of claim 10, wherein:
the computer-code instructions, in execution with the at least one processor, further cause the apparatus to, in performance of the at least one response action:
generate at least one security protocol based at least in part on the at least one anomalous event definition; and
cause provision of the at least one security protocol to at least one computing device associated with an administrator of the at least one computing environment.

16. The apparatus of claim 15, wherein:
the at least one security protocol defines at least one adjustment to account authentication policies; and
the at least one adjustment indicates an implementation of at least one of account lockout protocol, multifactor authentication protocol, or credential management protocol.

17. The apparatus of claim 15, wherein:
the at least one security protocol defines at least one adjustment to subsequent real-time monitoring of operations occurring on the at least one computing environment; and
the at least one adjustment is associated with at least one of application log monitoring, command monitoring, or user account monitoring.

18. The apparatus of claim 15, wherein:
the at least one security protocol defines at least one data management process to reduce vulnerability of the at least one computing environment to unauthorized data manipulation; and
the at least one data management process comprises at least one of data backup, data modification monitoring, or data encryption.

19. The apparatus of claim 15, wherein:
the at least one security protocol defines at least one communication control process to reduce vulnerability of the at least one computing environment to network intrusion; and
the at least one communication control process comprises at least one of signature verification, communication content filtering, or network traffic flow monitoring.

20. A computer program product comprising at least one non-transitory computer-readable storage medium having computer program code stored thereon that, in execution with at least one processor, is configured to:
monitor system data associated with at least one operation occurring in at least one computing environment;
predict a predictive output, using at least one machine learning model and based at least in part on the system data, the predictive output indicative of whether the system data is associated with at least one of a plurality of anomalous event definitions, wherein the at least one machine learning model is i) configured to generate the predictive output based on whether at least a portion of the system data indicates an aspect of an anomalous event as defined by a plurality of intrusion detection models, and ii) wherein the at least one machine learning model is trained on historical classifications of data processed using the plurality of intrusion models; and
in response to the predictive output perform at least one response action that reduces vulnerability of the at least one computing environment to anomalous activity in the at least one operation.
